(19) United States
(12) Patent Application Publication
(10) Pub. No.: US 2014/0139313 A1
(43) Pub. Date: May 22, 2014

(54) MAGNETIC CORE AND BOBBIN AND TRANSFORMER USING THE SAME

(71) Applicant: DELTA ELECTRONICS, INC., Taoyuan Hsien (TW)

(72) Inventors: Jinping Zhou, Taoyuan Hsien (TW); Teng Liu, Taoyuan Hsien (TW); Min Zhou, Taoyuan Hsien (TW); Minghui Dai, Taoyuan Hsien (TW); Yicong Xie, Taoyuan Hsien (TW)

(73) Assignee: DELTA ELECTRONICS, INC., Taoyuan Hsien (TW)

(21) Appl. No.: 13/843,858

(22) Filed: Mar. 15, 2013

(30) Foreign Application Priority Data
Nov. 21, 2012 (CN) 201210475294.4

(51) Int. Cl. H01F 3/00; B65H 75/14

(52) U.S. Cl. CPC H01F 3/00; B65H 75/14
USPC 336/84 C; 242/118.4; 335/297; 336/212

(57) ABSTRACT

The disclosure provides a magnetic core comprising a base, a center column, a first side column and a second side column fixed to the base. The first side column, the second side column and the center column are defined an annular space for accommodating a bobbin and/or a winding. The annular space have a first core opening and a second core opening thereon. A size of the first core opening between the first side column and the second side column is defined as a first core opening width. A size of the second core opening between the first side column and the second side column is defined as a second core opening width. Wherein at least one wire receiving space is provided at the base of the magnetic core, and the wire receiving space is located within the first core opening and/or the second core opening.

### CROSS-REFERENCE TO RELATED APPLICATIONS

This application claims benefits of Chinese Patent Application No. 201210475294.4, filed on Nov. 21, 2012 in the State Intellectual Property Office of China, the disclosure of which is incorporated herein by reference in its entirety.

### TECHNICAL FIELD

The present disclosure relates to a magnetic core, a bobbin and a transformer using the same for a power converter.

### BACKGROUND

In many conventional cores of transformers, the center column is located at the inner of the base plane. In the transformer using this type of core, the leads of the inner-layer windings may interfere with the shielding layer of metal foil and the outer-layer windings, which may thus affect the shielding effect and the coupling effect of the transformer. The following PJ type of core is described as an example.

Referring to FIGS. 1A and 1B, FIG. 1A is a perspective view of the traditional PJ type of core, and FIG. 1B is a top view of the core shown in FIG. 1A. The traditional PJ type of core mainly comprises a center column 11 with an outer-wall 111, a first side-column 12 with an inner-wall 121 and an outer-wall 122, a second side-column 13 with an inner-wall 131 and an outer-wall 132, an annular space 15 defined by the inner-wall 121 of the first side column, the inner-wall 131 of the second side column and the outer-wall 111 of the center column, and a base 14 located at the bottom of the annular space 15 and connected with the first side column 12, the second side column 13 and the center column 11. The annular space 15 comprises a first core opening 16 and a second core opening 17 located between the first side column 12 and the second side column 13 respectively. The first core opening 16 and the second core opening 17 are used for leads at opposite ends of the windings of the transformer to extend outside. The inner wall 121 of the first side column and the inner wall 131 of the second side column are at the same imaginary cylinder, the outer wall 122 of the first side column and the outer wall 132 of the second side column are at the same imaginary cylinder. That is, the inner wall 121 of the first side column and the inner wall 131 of the second side column project on the plane of the base 14 to be two arcs of an imaginary circle. Similarly, the outer wall 122 of the first side column and the outer wall 132 of the second side column project on the plane of the base 14 to be two arcs of an imaginary circle. Referring to the first core opening 16, the distance between the first side column 12 and the second side column 13 is defined as the width W1 of the first core opening. Referring to the second core opening 17, the distance between the first side column 12 and the second side column 13 is defined as the width W2 of the second core opening. The above core has the following advantages. Firstly, compared with the core having the square center column with the same area, the core having the cylindrical center column has shorter mean turn length and lower loss of the windings. Secondly, the annular space 15 is circular, thereby is suitable for the cylindrical windings and improves the place utilization. Further, compared with the conventional EC-type core, this core with the circular first side column and the circular second side column takes less space.

Referring to FIGS. 2A and 2B, FIGS. 2A and 2B are perspective view and front view of a bobbin structure corresponding to the PJ-type core shown in FIGS. 1A and 1B. The conventional bobbin 20 mainly comprises a first flange 21, a second flange 22 and a hollow cylinder 23 connecting with the first flange 21 and the second flange 22. As shown in FIG. 2B, the first flange 21 is parallel to the second flange 22, and a vertical distance between the first flange 21 and the second flange 22 defines the window width M. The windings are wound around the cylinder 23 and within the range of the window width M.

Referring to FIGS. 3A, 3B and 3C, FIG. 3A shows a transformer structure with the core shown in FIGS. 1A and 1B as well as the bobbin shown in FIGS. 2A and 2B. The conventional transformer comprises a first core 10a, a second core 10b, a bobbin 20 and windings 30. The center columns of the first core 10a and the second core 10b are located inside the cylinder 23 of the bobbin. The windings 30 comprise a primary winding and a secondary winding, which are wound around the bobbin 20 and within the range of the window width M. FIG. 3B is a sectional view along the line A-A shown in FIG. 3A. FIG. 3C is a schematic circuit diagram of the transformer shown in FIG. 3A. The windings 30 of this transformer comprise a primary side winding 31 with a first lead 31A and a second lead 31B, a secondary side winding 32 with a first lead 32A and a second lead 32B, and a metal foil shielding layer 33 wound between the primary side winding 31 and the secondary side winding 32. In application to various switching power supply configuration such as flyback converter and forward converter, a displacement current in the transformer is caused from the voltage jump between the primary winding 31 and the secondary winding 32, and flows into the ground, which forms the common mode noise. The metal foil shielding layer 33 is applied to shield the electric field coupling between the primary winding 31 and the secondary winding 32 to reduce the common mode noise.

In the conventional transformer described above, the first lead 31A and the second lead 31B of the first side winding 31 are drawn along the second flange 22 of the bobbin 20 and out of the first core opening 16 (as shown in 1B). Those two leads occupy the window width M of the bobbin, thereby bringing about the following negative effects. Firstly, because the metal foil shielding layer 33 is required to make room for the leads, the maximum width of the metal foil shielding layer 33 is restricted, and therefore the width thereof can not be as close as possible to the window width M of the bobbin, which affects the shielding effect between the primary side winding 31 and the secondary side winding 32. Secondly, the existence of the first lead 31A the second lead 31B may affect the arrangement of the secondary side winding 32 on outer side, such that the secondary side winding 32 can not be uniformly wound around the entire window width M of the bobbin. In this case, the coupling effect between the primary side winding 31 and the secondary side winding 32 will be deteriorated, thereby increasing the leakage of inductance. Thirdly, because the width of the metal foil shielding layer 33 and the width of the outside secondary side winding are both less than the window width M of the bobbin, during winding the windings, there is a certain arbitrariness in positioning the metal foil shielding layer or the secondary winding in the window width M of the bobbin, such as slightly upward or slightly downward, which leads to large individual differences in the shielding effect or the distributed capacitance between the primary winding 31 and the secondary winding 32 of respective products of a same batch as well as unreliability in the consistency. However, the consistency of the distributed capacitance is very important for the optimized design of the device such as EMI filter.

### SUMMARY

An embodiment of the present disclosure provides a core which can prevent the leads of the primary side winding from affecting the width of the metal foil shielding layer and can facilitate the secondary winding to wind around the core.

Another embodiment of the present disclosure provides a bobbin which can prevent the leads of the primary side winding from affecting the width of the metal foil shielding layer and can facilitate the secondary winding to wind around the bobbin.

Still another embodiment of the present disclosure provides a transformer which can improve the coupling effect and can reduce the inductance leakage between the primary side winding and the secondary side winding.

On one aspect, the present disclosure provides a magnetic core comprising a base, a center column, a first side column and a second side column fixed to the base. An inner wall of the first side column, an inner wall of the second side column and an outer wall of the center column are defined an annular space for accommodating a bobbin and/or a winding. The annular space have a first core opening and a second core opening oppositely provided thereon. A size of the first core opening between the first side column and the second side column is defined as a first core opening width. A size of the second core opening between the first side column and the second side column is defined as a second core opening width. Wherein at least one wire receiving space is provided at the base of the magnetic core, and the at least one wire receiving space is located within the first core opening and/or the second core opening. A maximum size of the wire receiving space within the first core opening along a width direction of the first core opening is defined as a first width of the wire receiving space, which is less than the first core opening width. A maximum width of the wire receiving space with the second core opening along a width direction of the second core opening is defined as a second width of the wire receiving space, which is less than the second core opening width.

According to one embodiment of the present disclosure, wherein the wire receiving space is a base opening cutting through the base.

According to one embodiment of the present disclosure, wherein the wire receiving space is a base groove which does not cut through the base and communicates with the annular space.

According to one embodiment of the present disclosure, wherein the magnetic core comprises a first wire receiving space defined in the first core opening, a maximum depth of the first wire receiving space extending toward the center column is defined as a depth of the first wire receiving space which reaches or does not reach the outer wall of the center column.

According to one embodiment of the present disclosure, wherein the magnetic core further comprises a second wire receiving space defined in the second core opening, a maximum depth of the second wire receiving space extending toward the center column is defined as a depth of the second wire receiving space which reaches or does not reach the outer wall of the center column.

According to one embodiment of the present disclosure, wherein the width of the first wire receiving space is equal to or not equal to that of the second wire receiving space.

According to one embodiment of the present disclosure, wherein the depth of the first wire receiving space is equal to or not equal to that of the second wire receiving space.

According to one embodiment of the present disclosure, wherein each wire receiving space has a shape of axial symmetry, two symmetrical axes of the two wire receiving spaces are in a same line located in a longitudinal section of the center column through an axis of the center column.

According to one embodiment of the present disclosure, wherein the width of the first wire receiving space is k times of the width of the first core opening, where k is in a range between 0 and 1; and/or wherein the width of the second wire receiving space is k times of the width of the second core opening, where k is in a range between 0 and 1.

According to one embodiment of the present disclosure, wherein k is in the range between 0 and 0.6.

According to one embodiment of the present disclosure, wherein the center column is at the center of the base or offsets from the center of the base.

According to one embodiment of the present disclosure, wherein the first core opening and the second core opening is symmetrically arranged or asymmetrically arranged.

According to one embodiment of the present disclosure, wherein the center column is cylindrical.

According to one embodiment of the present disclosure, wherein the inner walls of the first side column and the second side column are arc-shaped, and the annular space is of a ring shape.

According to one embodiment of the present disclosure, wherein the outer walls of the first side column and the second side column are arc-shaped.

On another aspect, the present disclosure provides a bobbin for use with the magnetic core comprising a first flange, a second flange and a hollow cylinder in connection with the first flange and the second flange. Wherein at least one bobbin opening is provided at the first flange and/or the second flange and corresponds to at least one wire receiving space of the core.

According to one embodiment of the present disclosure, wherein the first flange and/or the second flange are provided with at least one protrusion. At least one bobbin opening is provided at the protrusion and extends along the first flange and/or the second flange toward the hollow cylinder. Each protrusion has a limitation plane on a side connected with the first flange or the second flange. The limitation plane of each protrusion is in contact and matches with one of opposite side walls of the base of the magnetic core.

According to one embodiment of the present disclosure, wherein one or two of the protrusions are provided with multiple pins.

On another aspect, the present disclosure provides a transformer comprising a bobbin of present disclosure, a first core, a second core and a coil winding. Wherein the first core and/or the second core are as claimed in claim 1, and the center columns of the first core and the second core are accommodated inside the hollow cylinder of the bobbin respectively. Wherein the bases of the first core and the second core are in contact with the first flange and the second flange of the bobbin, respectively. The coil winding is wound around the hollow cylinder and between the first flange and the second flange of the bobbin. Wherein at least one lead of the coil winding passes through a corresponding bobbin opening and is drawn out of the wire receiving space of the core.

According to one embodiment of the present disclosure, wherein the coil winding comprises at least one primary side winding and at least one secondary side winding, between which a metal foil shielding layer is provided.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

### BRIEF DESCRIPTION OF THE DRAWINGS

The present invention will become more fully understood from the detailed description given hereinafter and the accompanying drawings which are given by way of illustration only, and thus are not limitative of the present invention and wherein:

FIG. 1A is a perspective view of a conventional PJ type of core.

FIG. 1B is a top view of the conventional PJ type of core shown in FIG. 1A.

FIG. 2A a perspective view of a conventional bobbin corresponding to the core shown in FIG. 1A.

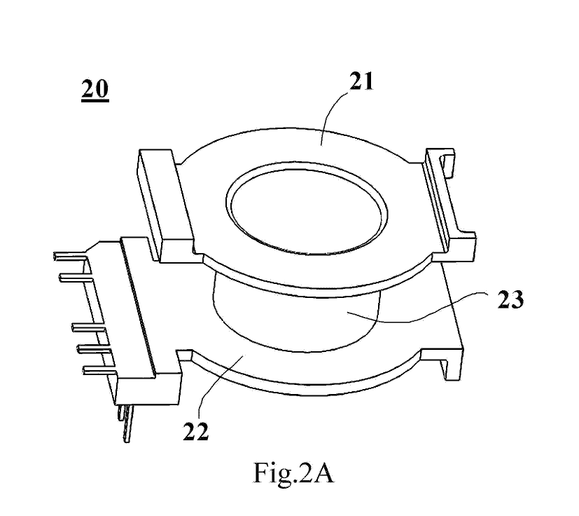

FIG. 2B is a top view of the conventional bobbin shown in FIG. 2A.

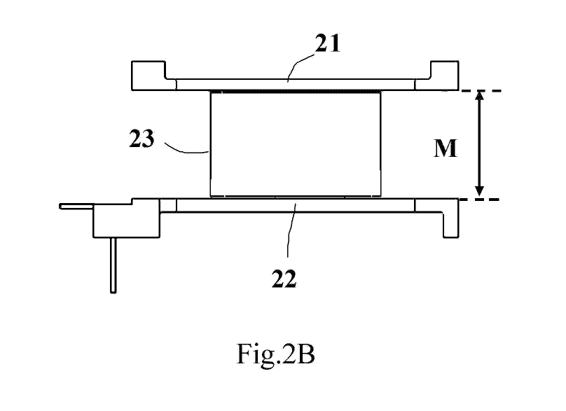

FIG. 3A is a perspective view of a conventional transformer with the core shown in FIG. 1A and the bobbin shown in FIG. 2A.

FIG. 3B is a sectional view along the line A-A shown in FIG. 3A.

FIG. 3C is a schematic circuit diagram of the transformer shown in FIG. 3A.

FIG. 4A is a perspective view of the core of the first embodiment of the invention.

FIG. 4B is a top view of the core of the first embodiment shown in FIG. 4A.

FIG. 5 is a schematic structural view of the core of the second embodiment of the invention.

FIG. 6 is a schematic structural view of the core of the third embodiment of the invention.

FIG. 7 is a schematic structural view of the core of the forth embodiment of the invention.

FIG. 8 is a schematic structural view of the core of the fifth embodiment of the invention.

FIG. 9A is a schematic structural view of the core of the sixth embodiment of the invention.

FIG. 9B is a top view of the core of the sixth embodiment shown in FIG. 9A.

FIG. 10A is a perspective view of the bobbin in one embodiment of the invention.

FIG. 10B is a front view of the bobbin in one embodiment of the invention.

FIG. 11A is a perspective view of the transformer of the first embodiment of the invention.

FIG. 11B is a sectional view along the line B-B shown in FIG. 11A.

FIG. 11C is a schematic structural view showing that the leads of the primary side winding and the secondary side winding passing through the opening of the bobbin.

FIG. 12A is a perspective view of the transformer of the second embodiment of the invention.

FIG. 12B is a sectional view along the line C-C shown in FIG. 12A.

FIG. 12C is a schematic circuit diagram of the transformer of the second embodiment shown in FIG. 12A.

FIG. 13 is a sectional structural view of the transformer of the third embodiment of the invention.

### DETAILED DESCRIPTION

The embodiment of the invention being thus described, it will be obvious that the same may be varied in many ways. Such variations are not to be regarded as a departure from the spirit and scope of the invention, and all such modifications as would be obvious to those skilled in the art are intended to be included within the scope of the following claims.

The features and advantages of the present disclosure will be embodied in the following detailed description of some exemplary embodiments. It will be understood that various changes in different manner do not depart from the scope of the present disclosure, and the description thereof is for the illustrative purpose in essence but not to limit the present disclosure. Many embodiments will be disclosed with reference to the following figures. For the sake of clarity, many practical details will be described as well. However, it is understood that those practical details are not provided to limit the present disclosure. That is, some practical details may be unnecessary in part of the present embodiments. In addition, for the sake of simplifying figures, some conventional structures and assemblies are represented in figures in schematic manner.

The inventive conception of the present core is that the wire receiving space is defined in the core base, two leads of the inner layer winding extend through the wire receiving space, and thus the interference of the leads of the inner layer winding with the metal foil shielding layer and the outer layer winding can be avoided. The wire receiving space can be selected from a group consisting of a base opening cutting through the base and a base groove without cutting through the base. The following PJ type of core is described as an example.

### The First Embodiment of the Magnetic Core

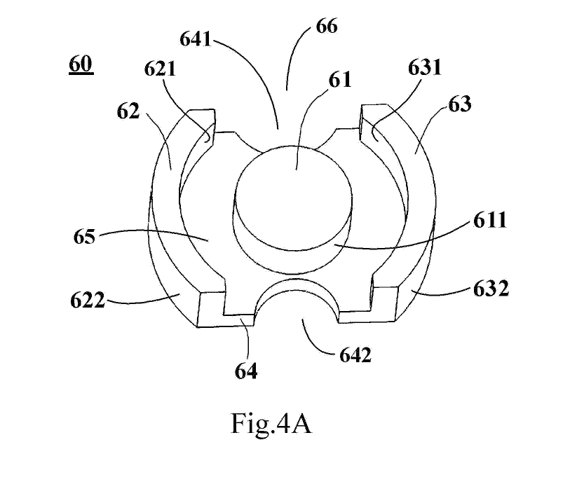

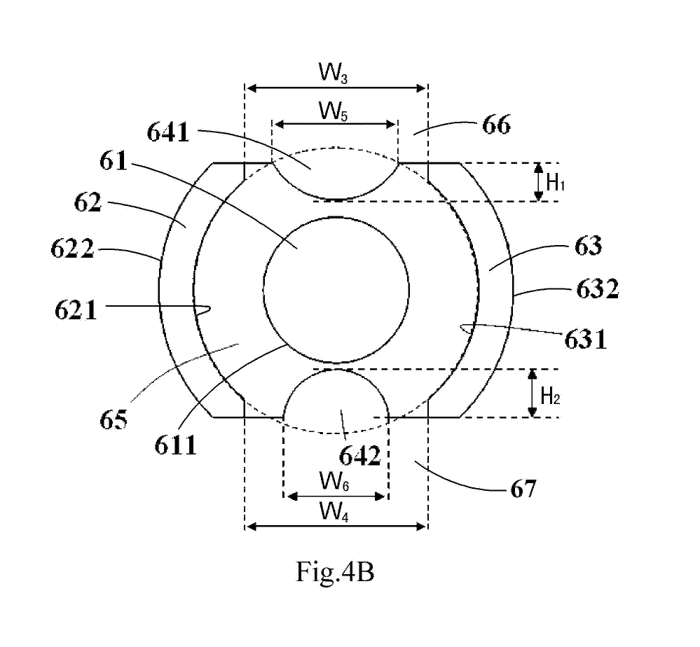

Referring to FIGS. 4A and 4B, FIG. 4A is a perspective view of a magnetic core according to the first embodiment, and FIG. 4B is a top view of the core shown in FIG. 4A. The core according to the first embodiment comprises a center column 61, a first side column 62, a second side column 63, a base 64 and an annular space 65. The center column 61, the side column 62 and the second side column 63 are all fixed to the same surface of the base 64.

The center column 61 with an outer wall 611 is of cylindrical shape and fixed at the center of the base 64. The first side column 62 and the second side column 63 are arranged symmetrically with respect to the center column 61.

The first side column 62 comprises an inner wall 621 and an outer wall 622, both of which are arc-shaped.

The second side column 63 comprises an inner wall 631 and an outer wall 632, both of which are arc-shaped.

The outer wall 622 of the first side column 62 and the outer wall 632 of the second side column 63 are on the same imaginary cylinder, which means that the projections of the outer wall 622 and the outer wall 632 on the surface of the base 64 are two arcs of a circle. The inner wall 621 of the inner side column 62 and the inner wall 631 of the second side column 63 are on the same imaginary cylinder, which means that the projections of the outer wall 621 and the outer wall 631 on the surface of the base 64 are two arcs of a circle. A central axis of the center column 61 is collinear with central axes of the imaginary cylinders with the inner walls 621, 631 and the outer walls 622, 632, respectively.

The annular space 65 for receiving a bobbin is defined by the inner wall 621 of the first side column 62, the inner wall 631 of the second side column 63 and the outer wall 611 of the center column 61. The annular space 65 comprises a first core opening 66 and a second core opening 67 in the opposite arrangement. A size of the first core opening 66 between the first side column 62 and the second side column 63 is defined as the width W3 of the first core opening 66, and a size of the second core opening 67 between the first side column 62 and the second side column 63 is defined as the width W4 of the second core opening 67. For example, the width W3 of the first core opening 66 is equal to the width W4 of the second core opening 67.

A first base opening 641 and a second base opening 642 are defined at the base 64, and the first base opening 641 is defined inside the first core opening 66. A maximum size of the first base opening 641 along a width direction of the first core opening 66 is defined as the width W5 of the first base opening 641, which is less than the width W3 of the first core opening 66. For example, an equation of W5=k*W3 is met, where 0<k<1. In order to minimize an additional core loss caused by the first base opening, the value of K is generally less than 0.9, such that the additional core loss may be less than 20%. The value of K is less than 0.6 according to an exemplary embodiment, the magnetic flux density in the zone is low, and thus the additional core loss may be less than 8%, which can be almost ignored. The second base opening 642 is defined inside the second core opening 67, a maximum size of the second base opening 642 along a width direction of the second core opening 67 is defined as a width W6 of the second base opening 642, which is less than the width W4 of the second core opening 67. A size relationship between the width W6 of the second base opening and the width W4 of the second core opening is substantially the same as that between the width W5 of the first base opening and the width W3 of the first core opening. In the first embodiment, the width W5 of the first base opening is larger than the width W6 of the second base opening.

The maximum distance of the first base opening 641 extending from the first core opening 66 toward the center column 61 is defined as the depth H1 of the first base opening, and the maximum distance of the second base opening 642 extending from the second core opening 67 toward the center column 61 is defined as the depth H2 of the second base opening. In the first embodiment, the depth H1 of the first base opening is less than the depth H2 of the second base opening. Neither the first base opening 641 nor the second base opening 642 in the depth direction are extended to the outer wall 611 of the center column 61.

The first base opening 641 has a symmetrical axis and is arc-shaped, in which case the width W5 is larger than the depth H1. The second base opening 642 has a symmetrical axis and is of a semicircular shape, in which case a half of the width of the second base opening W6 is equal to the depth H2. For example, the symmetrical axes of the first base opening 641 and the second base opening 642 are in the same line and located in a longitudinal section of the center column 61 through its center axis, such that the first base opening 641 and the second base opening 642 are in an opposite arrangement with respect to the center column 61. Alternatively, in consideration of actual situation, the first base opening 641 and the second base opening 642 may be staggered with each other about the center column 61.

In the first embodiment, neither the widths nor the depths are equal between the first base opening 641 and the second base opening 642, in which case the first base opening 641 and the second base opening 642 are thus in a non-symmetrical arrangement. The non-symmetry arrangement of the first base opening 641 and the second base opening 642 includes multiple situations. Generally speaking, the non-symmetry arrangement can be met as long as the first base opening 641 and the second base opening 642 have different widths and/or different depths.

### The Second Embodiment of the Magnetic Core

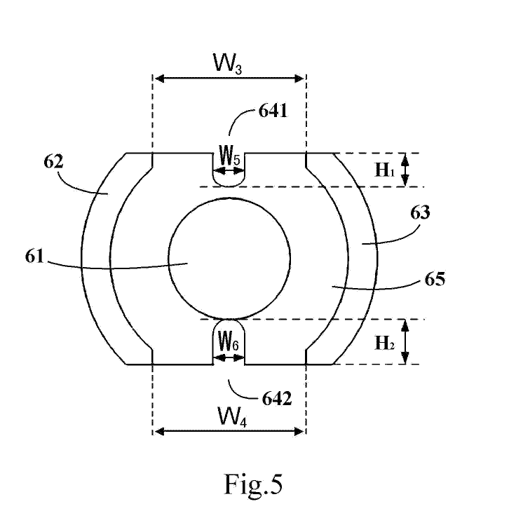

As shown in FIG. 5, the core of the second embodiment has substantially the same structure as that of the first embodiment, and the difference therebetween is that the first base opening 641 and the second base opening 642 are arch-shaped. In this case, the depth of the first base opening H1 is larger than the width of the first base opening W5 and the depth of the second base opening H2 is larger than the width of the second base opening W6. The second base opening 642 extends in the depth direction to the outer wall 611 of the center column 61, and the width W5 of the first base opening 641 is larger than the width W6 of the second base opening 642.

The other parts of the core of the second embodiment have the same structure as that of the first embodiment, and a detailed description thereof is omitted.

### Third Embodiment of the Magnetic Core

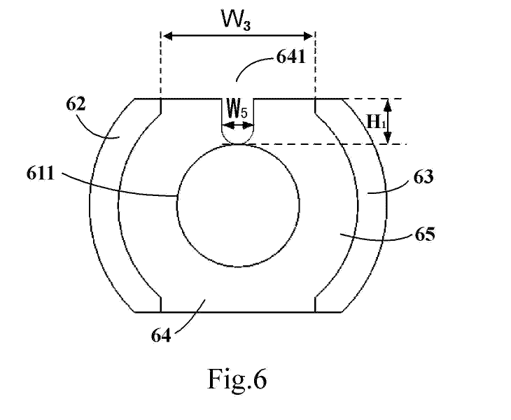

As shown in FIG. 6, the core of the third embodiment has substantially the same structure as that of the second embodiment, and the difference therebetween is that only one first base opening 641 is defined in the base 64, and the first base opening 641 extends in the depth direction to the outer wall 611 of the center column 61.

The other parts of the core of the third embodiment have the same structure as that of the second embodiment, and a detailed description thereof is omitted.

### Forth Embodiment of the Magnetic Core

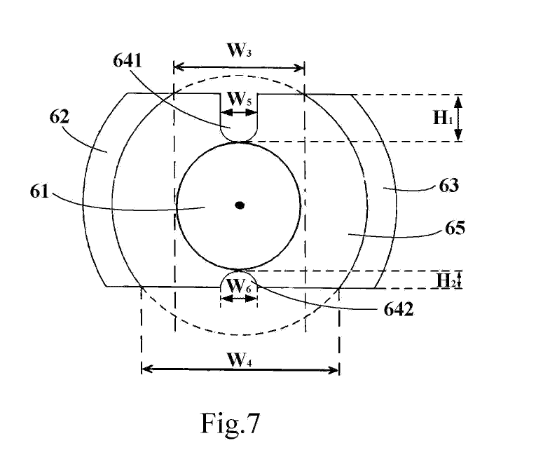

As shown in FIG. 7, the core of the forth embodiment has substantially the same structure as that of the second embodiment, and the difference therebetween is that the width W3 of the first core opening 66 is less than the width W4 of the second core opening 67. The first base opening 641 is arch-shaped and the second base opening 642 is of a semicircular shape. Furthermore, the first base opening 641 and the second base opening 642 extend in respective depth directions to the outer wall 611 of the center column 61, and the depth H1 of the first base opening is larger than the depth H2 of the second base opening.

The other parts of the core of the forth embodiment have the same structure as that of the second embodiment, and a detailed description thereof is omitted.

### Fifth Embodiment of the Magnetic Core

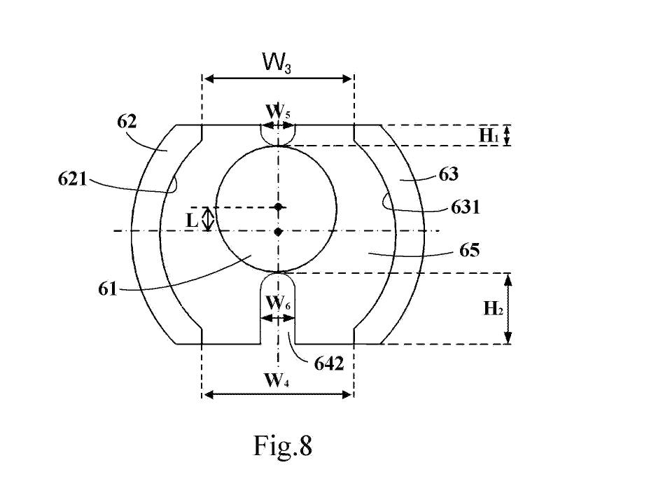

As shown in FIG. 8, the core of the fifth embodiment has substantially the same structure as that of the second embodiment, and the difference therebetween is that the axis of the center column 61 is parallel to and in a distance L from that of the imaginary cylinder with the inner wall 621 of the first side column and the inner wall 631 of the second side column. Both the first base opening 641 and the second base opening 642 are arch-shaped. The first base opening 641 and the second base opening 642 extend in the respective depth directions to the outer wall 611 of the center column 61, and the depth H1 of the first base opening is less than the depth H2 of the second base opening.

The other parts of the core of the fifth embodiment have the same structure as that of the second embodiment, and a detailed description thereof is omitted.

The cores of the forth embodiment and the fifth embodiment are modifications to the standard PJ type of core, the cores of the present disclosure are suitable not only for the PJ type of core but also for other modifications thereof and even for other type of cores such as EC type of core.

### Sixth Embodiment of the Magnetic Core

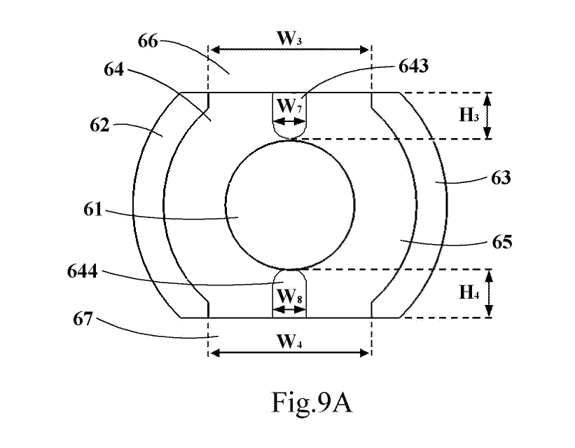

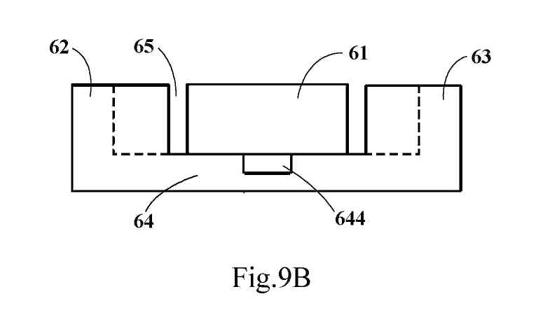

As shown in FIGS. 9A and 9B, the core of the sixth embodiment has substantially the same structure as that of the second embodiment, and the difference therebetween is that the wire receiving space 644 does not cut through the base 64 but is a groove in the base. Specifically, a first base groove 643 is defined on the base 64 and inside the first core opening 66, and the first base groove 643 communicates with the annular space 65. A maximum size of the first base groove 643 along a width direction of the first core opening 66 is defined as the width W7 of the first groove, which is less than the width W3 of the first core opening 66, in which case an equation of W7=k*W3 is met, where 0<k<1. In order to minimize an additional core loss caused by the first base groove, the value of K is generally less than 0.9, and thus the additional core loss may be less than 20%. For example, the value of K is less than 0.6, the magnetic flux density in the zone is low, and thus the additional core loss may be less than 8%, which can be almost ignored. The maximum distance of the first base groove 643 extending toward the center column 61 is defined as the depth H3 of the first base groove. A second base groove 644 is defined on the base 64 and inside the second core opening 67, and the second base groove 644 communicates with the annular space 65. A maximum size of the second base groove 644 along a width direction of the second core opening 67 is defined as the width W8 of the second groove, which is less than the width W4 of the second core opening. A size relationship between the width W8 of the second base groove and the width W4 of the second core opening is substantially the same as that between the width W7 of the first base groove and the width W3 of the first core opening. The maximum distance of the second base groove 644 extending toward the center column 61 is defined as the depth H4 of the second base groove. In the core of the sixth embodiment, the width W7 of the first base groove is equal to the width W8 of the second base groove, and the depth H3 of the first base groove is equal to the depth H4 of the second base groove. That means the first base groove 643 and the second base groove 644 are symmetrically arranged, which is not a limitation to the present disclosure. Alternatively, the widths and the depths may be unequal. In the core of the sixth embodiment, the first base groove 643 and the second base groove 644 extend in the respective depth directions to the outer wall 611 of the center column 61.

The other parts of the core of the sixth embodiment have the same structure as that of the second embodiment, and a detailed description thereof is omitted.

The specific structures of the cores according to the present embodiments are mentioned above only as examples. According to the conception of the present disclosure, there are other modifications, such as defining a base groove and a base opening at the base, or defining only one base groove at the base. The different structure of the cores in the respective embodiments may be in any free combination. For example, different width and/or different depth of base groove and/or base opening can be combined to achieve various implementations.

### First Embodiment of the Bobbin

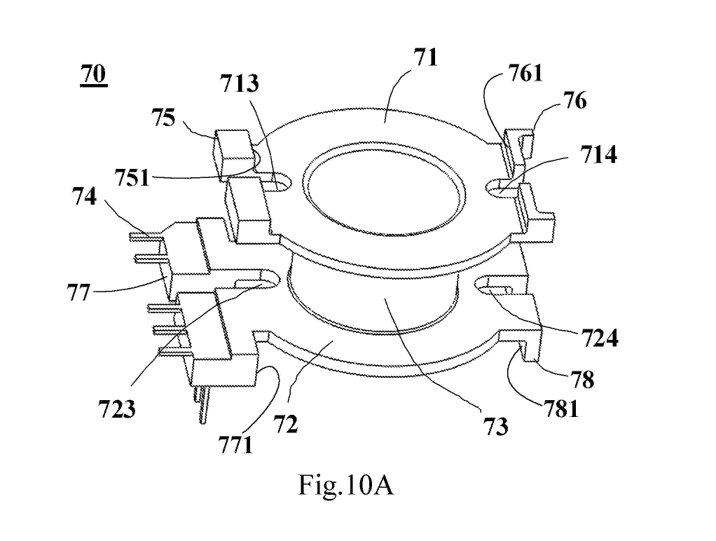

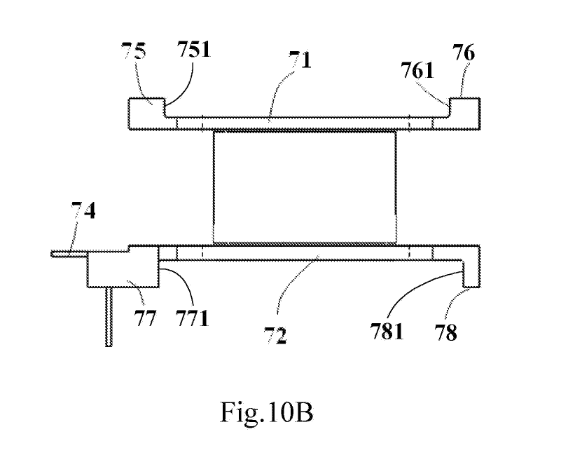

As shown in FIGS. 10A and 10B, a bobbin of the first embodiment comprises a first flange 71, a second flange 72 and a hollow cylinder 73. In other embodiments, the cylinder 73 may be replaced by a barrel with a polygonal section other than a hollow cylinder with a circular section. The cylinder 73 is in connection with the first flange 71 and the second flange 72, and a windings is wound around the cylinder 73. A first bobbin opening 713 and a second bobbin opening 714 are defined on the first flange 71. A third bobbin opening 723 and a forth bobbin opening 724 are defined on the second flange 72. After assembling two cores and the bobbin, the first bobbin opening 713, the second bobbin opening 714, the third bobbin opening 723 and the forth bobbin opening 724 correspond to two wire receiving spaces (base opening or base groove) of two cores respectively. In this configuration, leads at opposite ends of the windings around the cylinder 73 can pass through the respective bobbin openings and out of the wire receiving spaces of the bases, thereby eliminating the effect of two leads of the inner-layer winding on the metal foil shielding layer and the outer-layer winding.

In the bobbin of the first embodiment, two bobbin openings may be symmetrically defined only on the first flange 71 or only on the second flange 72, or only one bobbin opening may be defined only on the first flange 71 or the second flange 72.

### Second Embodiment of the Bobbin

The bobbin of the second embodiment has substantially the same structure as that of the first embodiment, and only the difference therebetween is described.

The first flange 71 is in connection with a first protrusion 75 provided with a first bobbin opening 713 and a second protrusion 76 provided with a second bobbin opening 714. The first bobbin opening 713 and the second bobbin opening 714 extend toward the cylinder 73. The first protrusion 75 comprises a first limiting plane 751 facing the first flange 71 and the second protrusion 76 comprises a second limiting plane 761 facing the first flange 71. The first limiting plane 751 and the second limiting plane 761 are in contact with two opposite sides of the corresponding core base respectively, for limiting the position of the assembled core.

The second flange 72 is in connection with a third protrusion 77 provided with a third bobbin opening 723 and a forth protrusion 78 provided with a forth bobbin opening 724. The third bobbin opening 723 and the forth bobbin opening 724 extend toward the cylinder 73. The third protrusion 77 comprises a third limiting plane 771 facing the second flange 72 and the forth protrusion 78 comprises a forth limiting plane 781 facing the second flange 72. The third limiting plane 771 and the forth limiting plane 781 are in contact with two opposite sides of the corresponding core base, for limiting the position of the assembled core.

The third protrusion is provided with a plurality of pins 74. Without a doubt, the pins can also be provided to any other protrusions.

The other parts of the bobbin of the second embodiment have the same structure as that of the first embodiment, and a detailed description thereof is omitted.

### First Embodiment of the Transformer

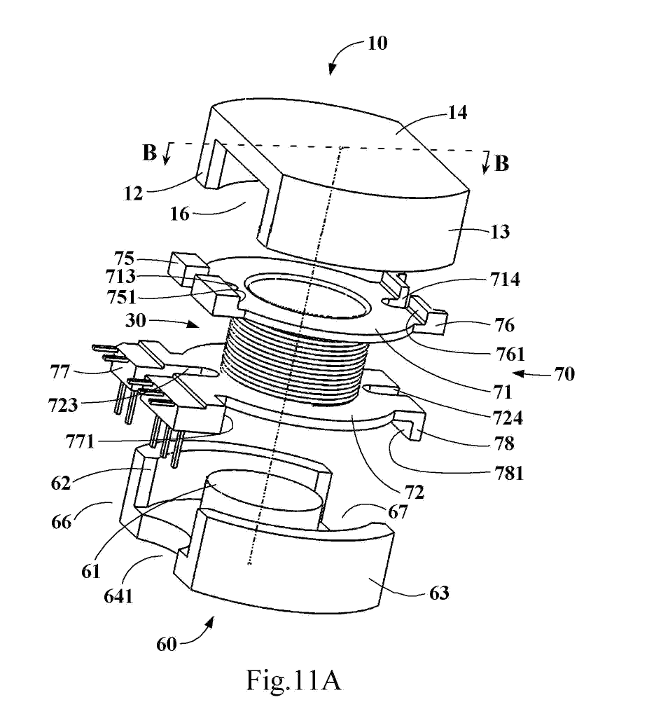

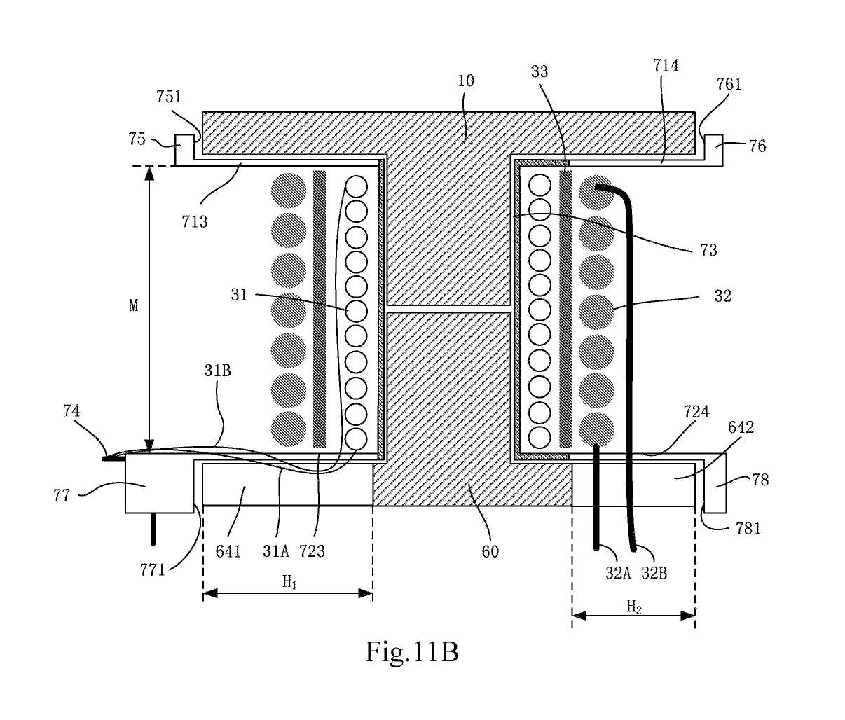

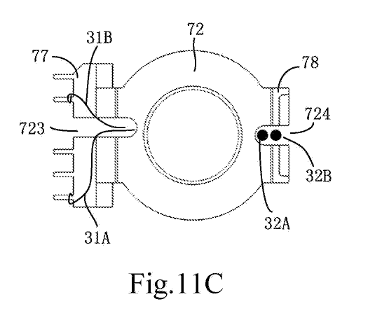

As shown in FIGS. 11A, 11B and 11C, FIG. 11A is a perspective view of the transformer of the first embodiment; FIG. 11B is a sectional view along the line B-B shown in FIG. 11A; FIG. 11C is a schematic structural view showing that the leads of the primary side winding and the secondary side winding pass through the opening of the bobbin. The transformer of the first embodiment comprises a first core 10, a second core 60, a bobbin 70 and a winding 30.

The first core 10 is a conventional PJ type of core which comprises a center column 11, a first side column 12, a second side column 13 and a base 14, wherein the center column 11 is fixed to the center of the base 14, the first side column 12 and the second side column 13 are fixed to the base 14 and are arranged symmetrically with respect to the center column 11.

The core 60 may be that according to the first embodiment of the magnetic core, and a detailed description thereof is omitted.

The bobbin 70 can be selected from any bobbins according to above embodiments, and a detailed description thereof is omitted.

The center columns of the first core 10 and the second core 60 are accommodated in the cylinder 73 of the bobbin 70, and the base 14 of the first core 10 and the base 64 of the second 60 are in contact with the first flange 71 and the second flange 72 of the bobbin 70 respectively.

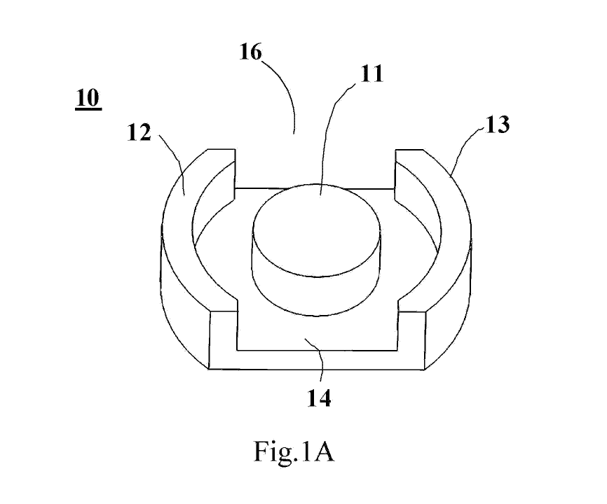

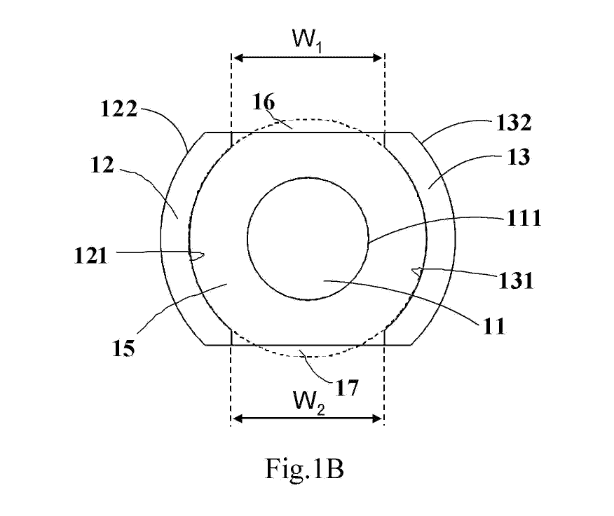

The first protrusion 75 and the second protrusion 76 of the first flange 71 extend outward from the first core opening 16 (shown in FIG. 1A) and the second core opening 17 of the first core 10. Further, the first limiting plane 751 and the second limiting plane 761 of the first flange 71 are in contact with side walls of the base 14 of the first core 10 respectively. Therefore, the first core 10 is fixed.

The third protrusion 77 and the forth protrusion 78 of the second flange 72 extend outward from the first core opening 66 and the second core opening 67 of the second core 60. Further, the third limiting plane 771 and the forth limiting plane 781 of the second flange 72 are in contact with side walls of the base 64 of the second core 60 respectively. Therefore, the second core 60 is fixed.

The coil winding 30 is wound around the cylinder 73 of the bobbin 70. The coil winding 30 comprises a primary side winding 31, a secondary side winding 32 and a metal foil shielding layer 33. The primary side winding 31 comprises a first lead 31A and a second lead 31B. The secondary side winding 32 comprises a first lead 32A and a second lead 32B. The metal foil shielding layer 33 is wound between the primary side winding 31 and the second winding 32. The first lead 31A and the second lead 31B of the primary side winding 31 pass through the third bobbin opening 723 of the bobbin 70 and the first base opening 641 of the base 64 of the second core 60, and then electrically connect with the pin 74. The first lead 32A and the second lead 32B of the secondary side winding 32 pass through the forth bobbin opening 724 of the bobbin 70, and extend out of the second base opening 642 of the base 64 of the second core 60.

In the transformer of the first embodiment, the first lead 31A and the second lead 31B of the primary side winding 31 in the inner layer extend out of the openings of the bobbin and the core without occupying the window width M of the bobbin, and thus the width of the metal foil shielding layer 33 can be as close as possible to the window width M of the bobbin. Therefore, the electric field shielding effect between the primary side winding 31 and the secondary side winding 32 is improved. Further, as the lead of the primary side winding 31 does not occupy the window width M, thus it does not interfere with the arrangement of the secondary side winding 32 in the outer layer. Therefore, the secondary side winding 32 are uniformly arranged within the window width M, and the coupling effect between the primary winding 31 and the secondary winding 32 is improved and the inductance leakage is reduced. Furthermore, the coil windings and the metal foil shielding layer 33 within the window width M can be controlled to the right position rather than an upward or downward position. Thus, during mass production, the consistency of the distributed capacitance between the primary side winding and the second side winding of the transformer in the first embodiment can be controlled, which plays an important role in the optimization design of the EMI filter.

In consideration of the difference of the diameters of the winding wires and the outgoing positions on the core of the leads of the first and second side windings, the width and the depth of the wire receiving space of the core can be designed in accordance with the practical circumstances. For example, the wire receiving space on opposite sides of the core can be symmetrical (two wire receiving spaces of the base having the same depth and the same width) or be asymmetrical (two wire receiving spaces of the base having different depth or/and different width). In one embodiment, the coil windings has small wire diameter, thus the width of the wire receiving space may be designed small, for example, as small as 30% of the width of the core opening. In another embodiment, the coil windings has large wire diameter, or is in a shunt-wound structure with multiple wires. In order to facilitate the extending of the leads of the windings, it is required that the width of the wire receiving space is large, for example, 60% of the width of the core opening.

The depth of the wire receiving space of the base can be designed in accordance with the practical circumstances. In one embodiment, it is required that the leads of the winding in the innermost layer can be extended out of the wire receiving space, thus the depth of the wire receiving space extends to the outer wall of the center column. In another embodiment, it is required that the leads of the winding in the middle layer can be extended out of the wire receiving space, thus the depth of the wire receiving space may not extend to the outer wall of the center column, rather, it only needs to extend to this winding. The concept in the size design of the wire receiving spaces of the bases in above cores is that the wire receiving space is as small as possible as long as the leads of the windings in the inner layer can smoothly extend outward, thereby reducing the negative impact of the core loss due to the wire receiving space in the core.

In accordance with the size of the wire receiving space (the width and the depth of the opening or the groove) of the core base, the size (the width and the depth) of the bobbin opening corresponding to the primary side winding, such as the sizes of the first bobbin opening 713 and the third bobbin opening 723, and the size of the bobbin opening corresponding to the secondary side winding, such as the sizes of the second bobbin opening 714 and the forth bobbin opening 724, can be designed according to practical conditions. The bobbin opening of the first flange may or may not correspond to that of the second flange, and the bobbin openings of each flange can be symmetrical or asymmetrical with each other. Similarly, the concept in the size design of the bobbin is that the size of the bobbin opening is as small as possible as long as the leads of the windings in the inner layer can be smoothly drawn out, thereby reducing the impact of the bobbin opening on the strength of the bobbin.

For example, in the first embodiment of the transformer, the primary side winding 31 is in the inner layer, the secondary side winding 32 is in the outer layer, and the leads position of the primary side winding is closer to the center column of the core compared with that of the secondary side winding. In other words, the depth H1 of the first base opening 641 in the second core 60 is deeper than the depth H2 of the second base opening 642, the second base opening 642 extends toward the center column and only reaches a position corresponding to the metal foil shielding layer 33. Further, the wire diameter of the primary side winding 31 is less than that of the secondary side winding 32, and thus the width W5 (as shown in FIG. 4B) of the first base opening 641 in the second core 60 is less than the width of the second base opening W6 of the second base opening 642. This asymmetrical structure is beneficial for reducing the core loss. Accordingly, the depth of the third bobbin opening 723 of the bobbin 70 extending toward the cylinder 73 is deeper than that of the forth bobbin opening 724 extending toward the cylinder 73, and the width of the third bobbin opening 723 is less than that of the forth bobbin opening 724. However, the size of the bobbin opening may not be limited to that mentioned above, as long as the leads of the coil windings can be drawn out. In view of the processing convenience, the depth and the width of the third bobbin opening 723 and the forth bobbin opening 724 can be the same.

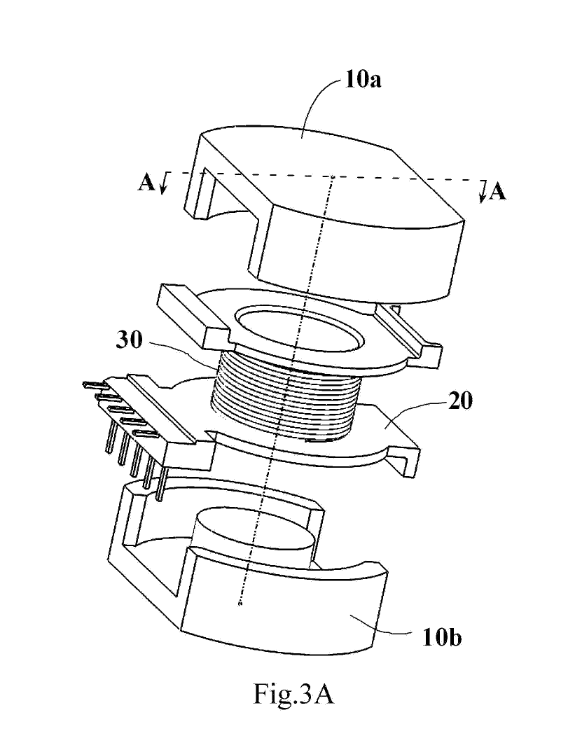

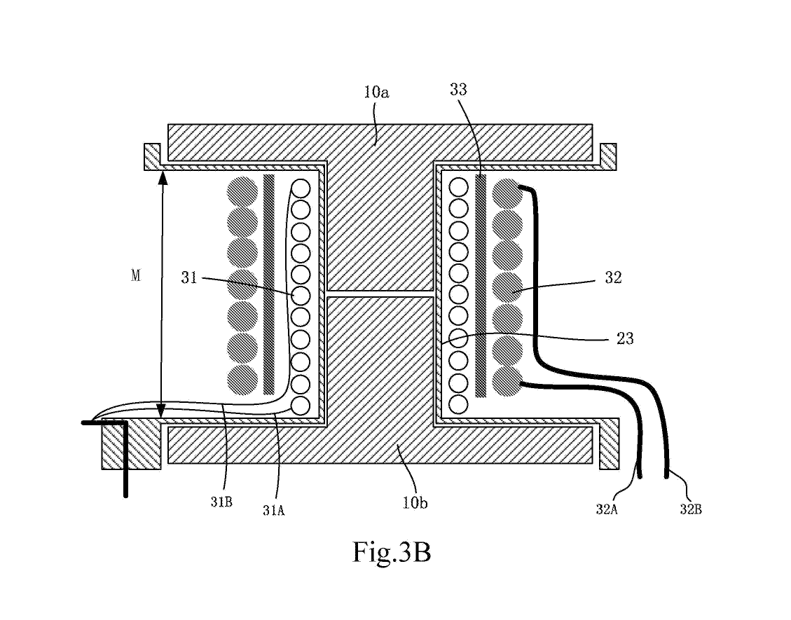

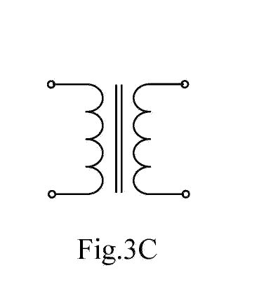

In the transformer of the first embodiment, no coil windings is wound outside the secondary side winding 32, there is no problem of the interference with the wire of the windings in the outer layer and the location of the metal foil shielding layer in the outer layer. Therefore, two leads of the secondary side winding can be in the same manner as that in the conventional transformer (as shown in FIG. 3B). In this case, the second base opening 642 may not be defined at the base 64 of the second core 60, and only the first base opening 641 may be defined for drawing out the lead of the primary side winding. Similarly, the forth bobbin opening 724 may not defined at the second flange 72 of the bobbin 70, and only the third bobbin opening 723 is defined for drawing out the lead of the primary side winding. Furthermore, the first bobbin opening 713 and the second bobbin opening 714 may not be defined at the first flange 71 of the bobbin 70.

### Second Embodiment of the Transformer

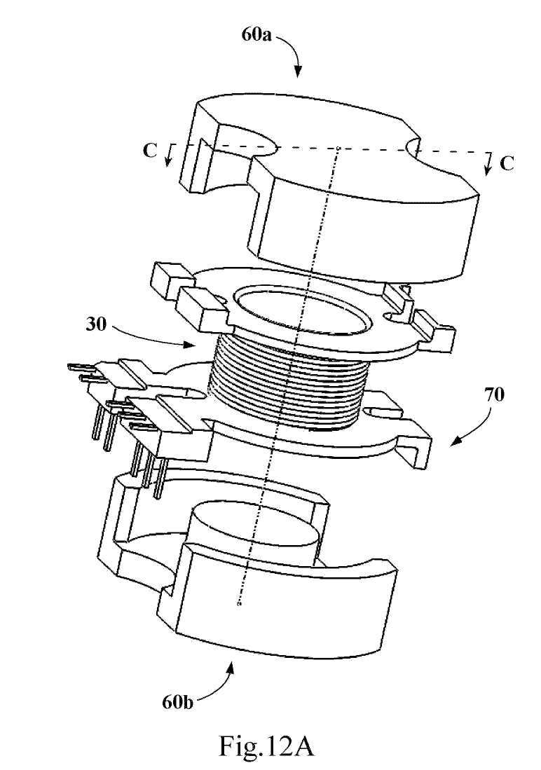

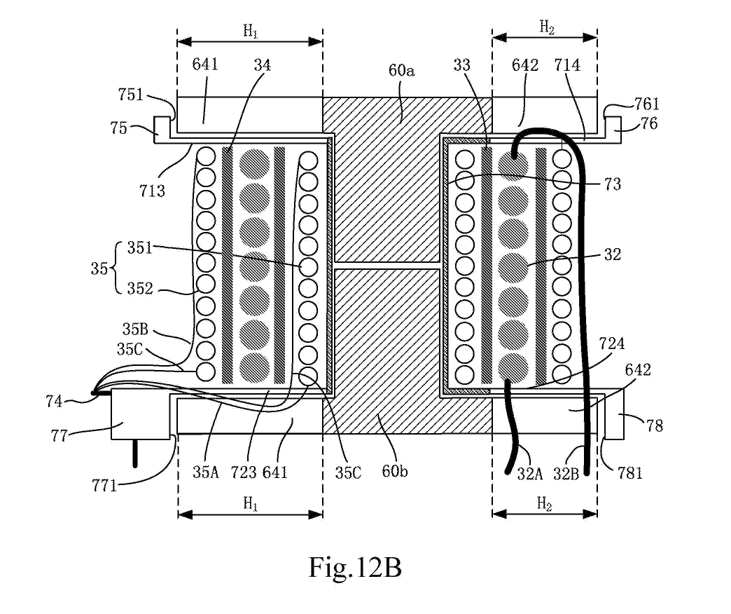

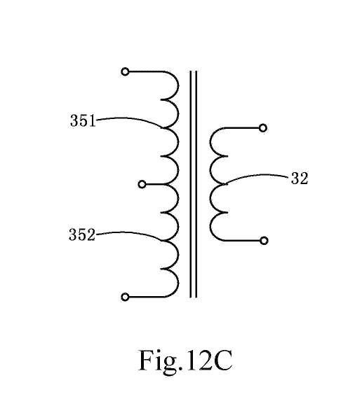

As shown in FIGS. 12A, 12B and 12C, FIG. 12A is a perspective view of a transformer of the second embodiment. FIG. 12B is a sectional view along the line C-C shown in FIG. 12A. FIG. 12C is a schematic circuit diagram of the transformer of the second embodiment shown in FIG. 12A. The transformer of the second embodiment comprises a first core 60a, a second core 60b, a bobbin 70 and a winding 30. The transformer of the second embodiment has substantially the same structure as that of the first embodiment, and only the difference therebetween is described herein.

The first core 60a and the second core 60b may be the same as the core according to the first embodiment.

The coil winding 30 has a complex sandwich structure and comprises a primary side winding 35, a secondary side winding 32, a metal foil shielding layer 33 and a second metal foil shielding layer 34. The primary side winding 35 comprises a first lead 35A, a second lead 35B and a center tap lead 35C, in which the winding portion between the first lead 35A and the center tap lead 35C constitutes a first portion of the primary side winding 351, the winding portion between the center tap lead 35C and the second lead 35B constitutes a second portion of the primary side winding 352. The secondary side winding 32 comprises a first lead 32A and a second lead 32B. The cylinder 73 of the bobbin 70 is wound around by the first portion of the primary side winding 351, the metal foil shielding layer 33, a secondary side winding 32, a second metal foil shielding layer 34 and the second portion of the primary side winding 352 in sequence from inner to outer. The first portion of the primary side winding 351, the secondary side winding 32 and the second portion of the primary side winding 352 constitute a sandwich structure. The first lead 35A of the first portion 351 of the primary side winding and the inner layer portion of the center tap lead 35C pass through the third bobbin opening 723 of the bobbin 70 and the first base opening 641 of the second core 60b, and then electrically connect with the pin 74, and thus will not interfere with the arrangement of the secondary side winding 32 and the second portion of the primary side winding 352, thereby the negative effect on the metal foil shielding layer 33 and the second metal foil shielding layer 34 is avoided. Therefore, the metal foil shielding layer 33 and the second metal foil shielding layer 34 can occupy the entire window width of the bobbin as far as possible. The second lead 35B of the second portion 352 of the primary side winding and the outer layer portion of the center tap lead 35C electrically connect with the pin 74 directly. The first lead 32A of the secondary side winding 32 passes through the forth bobbin opening 724 of the bobbin 70, and is drawn out of the second base opening 642 of the base 64 of the second core 60b. The second lead 32B of the secondary side winding 32 passes through the second bobbin opening 714 of the bobbin 70 and the second base opening 642 of the base 64 of the first core 60a to turn away from the second metal foil shielding layer 34, then passes through the forth bobbin opening 724 of the bobbin 70, and thus is drawn out of the second base opening 642 of the base 64 of the second core 60b. Thus, all the leads do not occupy the window width M of the bobbin, the width of the metal foil shielding layer 33 and the second metal foil shielding layer 34 may be as large as possible. The secondary side winding 32 and the second portion 352 of the primary side winding can be uniformly arranged in the range of the entire window width M of the bobbin, thereby greatly improving the shielding performance and the coupling performance.

In the transformer of the second embodiment, the primary side winding comprises two portions sandwiching the secondary side winding therebetween, and the metal foil shielding layer is provided between the secondary side winding and each portion of the primary side winding. In the practical application, the transformer can have in multiple modification manners, for example, the primary side winding comprises three or four portions, or the secondary side winding also comprises multiple portions. Thus the metal foil shielding layer is provided between two adjacent portions of the primary side winding and the secondary side winding respectively, and the good shielding effect between the respective portions of the windings is achieved.

The other parts of the transformer of the second embodiment have the same structure as that of the first embodiment, and a detailed description thereof is omitted.

### Third Embodiment of the Transformer

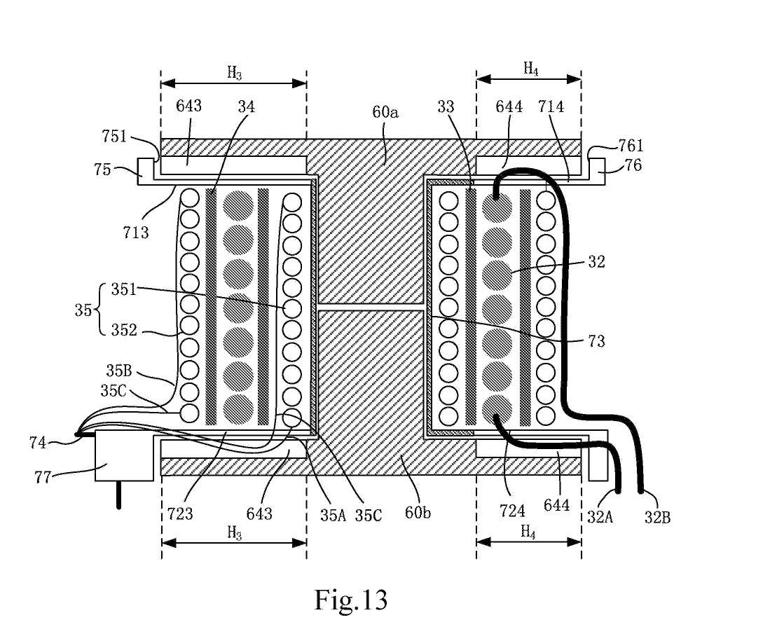

As shown in FIG. 13, the transformer of the third embodiment has substantially the same structure as that of the second embodiment, and the difference therebetween is that: there are no first base opening 641 and the second base opening 642 passing through the base provided on the first core 60a and the second core 60b for drawing out the leads, rather, there are a first base groove 643 and a second base groove 644 provided thereon. Namely, the core of the sixth embodiment is applied to the transformer of the third embodiment. The base groove takes place of the base opening, thereby further reducing the core loss of the transformer.

The other parts of the transformer of the third embodiment have the same structure as that of the second embodiment, and a detailed description thereof is omitted.

The transformer of the present disclosure is not limited to the above embodiment. In the practical manufacture, the transformer can be manufactured by freely combining the bobbin of any one embodiment and the core of any one embodiment or any one conventional core.

One or more beneficial effects provided by one or more exemplary embodiments are described as below.

The wire receiving space of the base is provided, leads of the winding in the inner layer extend through the wire receiving space of the base, and thus the interference of the leads of the inner layer winding with the metal foil shielding layer can be avoided.

The bobbin opening is provided at the flanges for the leads of the windings in the inner layer passing through, thereby preventing the interference of the leads of windings in the inner layer with the metal foil shielding layer and the windings in the outer layer.

In the transformer comprising the present core and the present bobbin, as the leads do not occupy the window width of the bobbin, the shielding effect between the primary side windings and the secondary side windings is good.

The transformer has good coupling effect and low inductance leakage between the primary side windings and the secondary side windings due to the uniform arrangement of the wire of the windings in the outer layer.

The individual differences in the distributed capacitance of the individual products in the same batch are reduced, and thus the requirement for the consistency of the individual products can be essentially met.

And it should be noted that the above embodiments is only illustrated for describing the technical solution of the invention and not restrictive, and although the invention is described in detail by referring to the aforesaid embodiments, the skilled in the art should understand that the aforesaid embodiments can be modified and portions of the technical features therein may be equally changed, which does not depart from the spirit and scope of the technical solution of the embodiments of the invention.

1. A magnetic core, comprising:
a base;
a center column;
a first side column and a second side column fixed to the base, an inner wall of the first side column, an inner wall of the second side column and an outer wall of the center column defining an annular space for accommodating a bobbin and/or a winding, the annular space having a first core opening and a second core opening oppositely provided thereon, a size of the first core opening between the first side column and the second side column being defined as a first core opening width, a size of the second core opening between the first side column and the second side column being defined as a second core opening width,
wherein at least one wire receiving space is provided at the base of the magnetic core, and the at least one wire receiving space is located within the first core opening and/or the second core opening, a maximum size of the wire receiving space within the first core opening along a width direction of the first core opening is defined as a first width of the wire receiving space, which is less than the first core opening width, and a maximum width of the wire receiving space with the second core opening along a width direction of the second core opening is defined as a second width of the wire receiving space, which is less than the second core opening width.

2. The magnetic core as claimed in claim 1, wherein the wire receiving space is a base opening cutting through the base.

3. The magnetic core as claimed in claim 1, wherein the wire receiving space is a base groove which does not cut through the base and communicates with the annular space.

4. The magnetic core as claimed in claim 1, wherein the magnetic core comprises a first wire receiving space defined in the first core opening, a maximum depth of the first wire receiving space extending toward the center column is defined as a depth of the first wire receiving space which does not reach the outer wall of the center column.

5. The magnetic core as claimed in claim 4, wherein the magnetic core further comprises a second wire receiving space defined in the second core opening, a maximum depth of the second wire receiving space extending toward the center column is defined as a depth of the second wire receiving space which does not reach the outer wall of the center column.

6. The magnetic core as claimed in claim 5, wherein the width of the first wire receiving space is not equal to that of the second wire receiving space.

7. The magnetic core as claimed in claim 6, wherein the depth of the first wire receiving space is not equal to that of the second wire receiving space.

8. The magnetic core as claimed in claim 5, wherein each wire receiving space has a shape of axial symmetry, two symmetrical axes of the two wire receiving spaces are in a same line located in a longitudinal section of the center column through an center axis of the center column.

9. The magnetic core as claimed in claim 1, wherein the width of the first wire receiving space is k times of the width of the first core opening, where k is in a range between 0 and 1; and/or wherein the width of the second wire receiving space is k times of the width of the second core opening, where k is in a range between 0 and 1.

10. The magnetic core as claimed in claim 9, wherein k is in the range between 0 and 0.6.

11. The magnetic core as claimed in claim 1, wherein the center column is at the center of the base.

12. The magnetic core as claimed in claim 11, wherein the first core opening and the second core opening is asymmetrically arranged.

13. The magnetic core as claimed in claim 11, wherein the center column is cylindrical.

14. The magnetic core as claimed in claim 11, wherein the inner walls of the first side column and the second side column are arc-shaped, and the annular space is of a ring shape.

15. The magnetic core as claimed in claim 11, wherein the outer walls of the first side column and the second side column are arc-shaped.

16. A bobbin for use with the magnetic core as claimed in claim 1, comprising a first flange, a second flange and a hollow cylinder in connection with the first flange and the second flange, wherein at least one bobbin opening is provided at the first flange and/or the second flange and corresponds to at least one wire receiving space of the core.

17. The bobbin as claimed in claim 16, wherein the first flange and/or the second flange are provided with at least one protrusion, at least one bobbin opening is provided at the protrusion and extends along the first flange and/or the second flange toward the hollow cylinder, each protrusion has a limitation plane on a side connected with the first flange or the second flange, the limitation plane of each protrusion is in contact and matches with one of opposite side walls of the base of the magnetic core.

18. The bobbin as claimed in claim 17, wherein one or two of the protrusions are provided with multiple pins.

19. A transformer, comprising a bobbin as claimed in claim 16, a first core, a second core and a coil winding,
wherein the first core and/or the second core are as claimed in claim 1, and the center columns of the first core and the second core are accommodated inside the hollow cylinder of the bobbin respectively,
wherein the bases of the first core and the second core are in contact with the first flange and the second flange of the bobbin, respectively, and the coil winding is wound around the hollow cylinder and arranged between the first flange and the second flange of the bobbin, and
wherein at least one lead of the coil winding passes through a corresponding bobbin opening and is drawn out of the wire receiving space of the core.

20. The transformer as claimed in claim 19, wherein the coil winding comprises at least one primary side winding and at least one secondary side winding, between which a metal foil shielding layer is provided.
